(19) United States
(12) Patent Application Publication
(10) Pub. No.: US 2013/0209807 A1
(43) Pub. Date: Aug. 15, 2013

(54) Functionalized Carbon Nanotube Sheets for Electrochemical Biosensors and Methods

(71) Applicant: Florida State University Research Foundation, Inc., (US)

(72) Inventor: Jhunu Chatterjee, Tallahassee, FL (US)

(73) Assignee: FLORIDA STATE UNIVERSITY RESEARCH FOUNDATION, INC., Tallahassee, FL (US)

(21) Appl. No.: 13/766,385

(22) Filed: Feb. 13, 2013

Related U.S. Application Data
(60) Provisional application No. 61/597,884, filed on Feb. 13, 2012.

(51) Int. Cl. H01J 9/02

(52) U.S. Cl. CPC H01J 9/02; B82Y 15/00
USPC 428/408; 445/58; 252/502; 252/510; 252/503; 977/784

(57) ABSTRACT

Electrodes and methods for making electrodes including modified carbon nanotube sheets are provided. The carbon nanotube sheets can be modified with metal particles or at least one mediator titrant. The electrodes can be disposed on a glassy carbon electrode to modify the glassy carbon electrode. Methods are provided that include forming a suspension of carbon nanotubes and metal particles or at least one mediator titrant, and filtering the suspension to form a modified carbon nanotube sheet.

### CROSS-REFERENCE TO RELATED APPLICATION

This reference claims priority to U.S. Provisional Patent Application No. 61/597,884, filed Feb. 13, 2012, which is incorporated herein by reference.

### FIELD OF THE INVENTION

This disclosure relates to modified carbon nanotube (CNT) sheets that can act as electrodes or parts of electrodes in sensors, including electrochemical biosensors.

### BACKGROUND

Conventional, or known, technology using CNT-modified electrodes to detect and determine biomolecules—such as tryptophan, tyrosine, cytochrome C, etc.—uses a glassy carbon electrode surface, and a liquid dispersion of modified CNT that modifies the surface of the glassy carbon electrode.

For example, this method can be used to detect myoglobin, which is an important protein and biomarker found in mammalian muscle tissues, including the heart and skeletal muscles. Myoglobin is responsible for oxygen storage and transportation throughout the body (Masuda, K. et al. EUR. J. APPL. PHYSIOL. 104, 2008, 41-48). Moreover, myoglobin provides extra oxygen to muscles that are being used for prolonged periods.

Although myoglobin is found in both cardiac muscle and in skeletal muscle, the detection of myoglobin levels is crucial in the early detection of myocardial infarction-related cardiac muscle injury. This toxic biomarker is the first biomarker released when the myocardial muscle cells are damaged. Myoglobin can be released into the bloodstream up to two hours prior to an incident, however, it drops below the level of detection approximately 12 hours thereafter, which makes detection a very time-sensitive process.

The detection of myoglobin in the kidneys also is very important. When muscles are damaged or cramped, the myoglobin in muscle cells is released into the bloodstream and removed by the kidneys. High levels of myoglobin can damage the kidneys due to its toxicity.

This method of modifying electrodes has certain disadvantages. These include the stability of the carbon nanotubes' dispersion, and its homogeneity when mixed with other materials, including metal particles, such as gold nanoparticles. Also, there are some experimental limitations, such as how much of the dispersion should be placed on the glassy carbon electrode surface to make a thin layer of the material to cover a 2-3 mm diameter area of the glassy carbon electrode and how evenly one can distribute this layer over the glassy carbon electrode surface.

Radioimmunoassay generally is used as the method to detect myoglobin (Kitao, T. et al., FORENSIC. SCI. INT. 71, 1995, 205-214); however, other processes such as electrochemical processes can be used in order to detect myoglobin levels (Ye, J. et al. ANAL. CHEM. 60, 1988, 2263-2268). These alternative processes, such as the electrochemical process, not only provide superior sensitivity, they also are much more cost effective. Moreover, processes such as radioimmunoassay and other methods used to detect myoglobin levels tend to be complicated and time consuming due to the analysis that is required.

Generally, myoglobin contains a single iron protoporphyrine moiety and can have various redox states. This makes it an electrochemically active molecule. Although it is an electrochemically active molecule, the location of the heme group in the innermost protein structure makes the response slower. The use of a mediator titrant, i.e., an electron transfer intermediate, can enhance the electron transfer so the titrant has an efficient electro catalytic reaction with myoglobin (see Ye, J. et al., Anal. Chem. 60, 1988,2263-2268; and Fultz, M. L., et al. ANAL. CHIM. ACTA 140, 1982, 1).

The use of mediator titrants, such as methylene blue, thionine, and pheazine methosulfate (PMS), previously have been used to modify electrodes chemically for the catalytic reduction of molecules such as myoglobin, hemoglobin, and cytochrome C. The problem with using these molecules to modify electrodes is the instability of the electrode due to the slow release of the molecule from the electrode surface. In order to provide higher stability, the use of carbon nanotubes has been proposed and several researchers have used carbon nanotubes to modify glassy carbon electrodes.

Carbon nanotubes have been used to modify glassy carbon electrodes by adding a dispersion containing multiple walled carbon nanotubes (MWNTs) and methylene blue (MB) to detect myoglobin (Pakapongpan, S. et al. PROCEEDINGS OF PURE AND APPLIED CHEMISTRY, 2011). It is believed that MB attaches to the surfaces of the MWNTs due to pi-pi interaction. Also, it is believed that using carboxyl modified carbon nanotubes enhances the hydrophobic interaction, thereby proving a stable attachment of MB. The dispersions, however, present the several disadvantages previously described, including maintaining the homogeneous dispersion and controlling the dispersion when it applied to a glassy electrode.

Methods are needed that overcome one or more of these disadvantages. Specifically, methods are needed that may avoid concerns about maintaining the homogeneous dispersion of CNTs; obtaining a quantitative attachment of metal nanoparticles to the CNTs; avoiding coating a glassy carbon electrode with a desirable amount of a dispersion; and cleaning the glassy carbon electrode.

### BRIEF SUMMARY

In one aspect, this disclosure provides electrodes comprising a carbon nanotube sheet and metal particles. In another aspect, this disclosure provides electrodes comprising a carbon nanotube sheet and at least one mediator titrant. The carbon nanotube sheets may comprise single-walled carbon nanotubes (SWNTs), multi-walled carbon nanotubes (MWNTs), carbon nanofibers (CNFs), or a combination thereof. The carbon nanotubes may be functionalized. In certain embodiments, the electrodes further comprise a glassy carbon electrode onto which the carbon nanotube sheet is arranged.

In yet another aspect, this disclosure provides methods for making an electrode comprising forming a suspension comprising carbon nanotubes and metal particles, or carbon nanotubes and at least one mediator titrant, and filtering the suspension to obtain a modified carbon nanotube sheet. In some embodiments, the suspension comprises a surfactant. The carbon nanotubes may comprise SWNTs, MWNTs, carbon nanofibers, or a combination thereof. The carbon nanotubes may be functionalized. The methods, in some embodiments, further comprise arranging the carbon nanotube sheet on a glassy carbon electrode.

### BRIEF DESCRIPTION OF THE DRAWINGS

FIG. 1 depicts cyclic voltammetry data collected when a gold modified CNT buckypaper is used as an electrode to detect of tyrosine, tryptophan, and L-carnitine.

FIG. 2 is a scanning electron micrograph of a gold modified CNT buckypaper.

FIG. 3 depicts the cyclic voltamogram for unmodified glassy carbon electrode in (A) buffer and (B) myoglobin in buffer.

FIG. 4 depicts the cyclic voltamogram for modified glassy carbon electrode with (A) MWCNT-MB dispersion and (B) MWCNT—MB buckypaper in myoglobin solution in PBS.

FIG. 5 is a scanning electron micrograph for methylene blue-modified MWNT bucky paper.

FIG. 6 is an atomic force micrograph for methylene blue-modified MWNT buckypaper.

### DETAILED DESCRIPTION

Other objects, features, and advantages of the invention will be apparent from the following detailed description, drawings, and claims. Unless otherwise defined, all technical and scientific terms and abbreviations used herein have the same meaning as commonly understood by one of ordinary skill in the art to which this invention pertains. Although methods and compositions similar or equivalent to those described herein can be used in the practice of the present invention, suitable methods and compositions are described without intending that any such methods and compositions limit the invention herein.

### CNT Sheets

The electrodes provided herein comprise CNT sheets made from CNTs. The electrodes are “modified CNT sheets.” These two terms—“electrodes” and “modified CNT sheets”—are used interchangeably throughout this specification. Also, the terms “CNT sheet” and “buckypaper” are used interchangeably throughout the specification.

Typically, CNTs are long, cylindrical molecules of carbon atoms that are arranged in a hexagonal lattice, as in graphite. Because carbon-carbon bonds are chemically and physically stable and strong, and because CNTs are seamless and have a very small diameter (1-50 nanometers), CNTs have exceptional properties. High-quality CNTs have several times the strength of steel piano wire at one-fourth the density, at least five times the thermal conductivity of copper, and very high electrical conductivity and current-carrying capacity. CNTs have exceptional electronic, thermal, and mechanical properties; and a sheet formed by CNTs may have an extremely high surface area, diverse capabilities for chemical modification and functionalization, and strong interactions with polymers and composite host materials. CNTs have good biocompatibility and can facilitate electron transfer of redox proteins and enzymes.

CNTs have excellent electronic properties, good chemical stability, and a large surface area. Not wishing to be bound by any particular theory, it is believed that the properties of CNTs allow buckypapers to provide an enhanced surface area and greater hydrophobicity in comparison to CNT powders that are used to form the previously used dispersions.

The compositions described herein include CNTs. The CNTs can include single-wall carbon nanotubes (SWNTs), multi-walled carbon nanotubes (MWNTs), carbon nanofibers (CNFs), or a combination thereof. In some embodiments, the CNTs are longer than about 100 μm. In other embodiments, the CNTs have a length of about 300 μm to about 500 μm. In further embodiments, the diameters of the CNTs are less than about 30 nm. In certain embodiments, the CNTs have a diameter of about 5 nm to about 15 nm. In one embodiment, the CNTs have a diameter of about 10 nm.

In some embodiments, the CNTs are functionalized. For example, the CNTs can be acid-functionalized, acid-modified, amino-functionalized, or a combination thereof. In one embodiment, the CNTs are carboxyl modified CNTs. The CNTs can be functionalized by any methods known in the art.

In one embodiment, the CNTs used to make the compositions are SWNTs in arm-chair, zig-zag, or chiral configurations. In some embodiments, the CNTs used to make the compositions can have open ends.

### Metal Particles

In addition to CNTs, embodiments of the electrodes described herein include metal particles. In some embodiments, the metal particles comprise gold, silver, platinum, or any combination thereof. In other embodiments, the metal particles comprise nanoparticles. In further embodiments, the metal particles comprise gold nanoparticles. Gold nanoparticles generally are biocompatible and, in some embodiments, show increased electron transfer ability when coupled with CNTs.

In one embodiment, the nanoparticles have an average diameter of less than 500 nm. In another embodiment, the nanoparticles have an average diameter of less than 400 nm. In another embodiment, the nanoparticles have an average diameter of less than 300 nm. In another embodiment, the nanoparticles have an average diameter of less than 200 nm. In another embodiment, the nanoparticles have an average diameter of less than 100 nm. In another embodiment, the nanoparticles have an average diameter of less than 50 nm. In some embodiments, the nanoparticles that satisfy one of these upper limitations have an average diameter of at least 10 to 40 nm.

In some embodiments, metal particles of different sizes or shapes are used to alter the electrical response towards a biomolecule, even without any specific group attached to it or without any kind of labeling.

The metal particles are associated with a CNT sheet (or “buckypaper”) to form the electrodes described herein. In some embodiments, the association is non-covalent. Methods for non-covalently forming CNT-gold nanohybrid materials are known in the art (see, e.g., Li, H. et al. ADV. FUNC. MATER. 20, 2010, 3864-3870; Raghuveer, M. S. et al. CHEM. MATER. 18, 2006, 1390-1393). Other methods and techniques are described in the Examples.

### Mediator Titrants

In addition to CNTs, embodiments of the electrodes described herein include at least one mediator titrant. Any mediator titrants known in the art that can result in a desired electrode may be used. In some embodiments, the at least one mediator titrant can include methylene blue (MB), thionine, or phenazine methosulfate (PMS).

In embodiments, the mediator titrant is non-covalently associated with the CNTs. In some embodiments, the at least one mediator titrant has favorable pi-pi interaction with the CNT sheet. The association of the at least one mediator titrant with the CNT sheet may be aided by favorable pi-pi interaction.

### Electrodes

The electrodes described herein comprise a CNT sheet and metal particles, or a CNT sheet and at least one mediator titrant. The metal particles or mediator titrant, in some embodiments, are dispersed throughout the CNT sheet. In other embodiments, the metal particles or mediator titrant are dispersed homogeneously throughout the CNT sheet.

The electrodes may be in the shape of thin sheets or films, and may be any size. In some embodiments, the size may depend on the particular application. In some embodiments, the electrodes are sized for use in the sensors previously known.

In some embodiments, the electrodes described herein may be arranged on a glassy carbon electrode. Since the electrodes are solid sheets, the electrodes described herein eliminate the need to modify a glassy carbon electrode with a liquid suspension. Therefore, the electrodes described herein, in some embodiments, avoid the need for forming a liquid suspension of CNTs and metal particles or a mediator titrant, maintaining the stability and homogeneity of the liquid suspension, placing an exact amount of a liquid suspension on a glassy carbon electrode, and the need to clean the glassy carbon electrode at the end of an experiment.

The electrodes described herein may be used with any sensors known in the art, such as electrochemical biosensors. Examples of electrochemical biosensors include potentiometric biosensors (ISM, ISFET), impedimetric biosensors, and amperometric biosensors (see Brno, J. APPL. BIOMEDICINE, 6:57-64, 2008).

The electrodes may be used in electrochemical bio sensors. The electrodes may be used to separate any molecule of interest, including, but not limited to, the following biomolecules: L-carnitine inner salt (3-carboxy-2-hydroxy-N,N,N,-tri-methyl-1-propanaminium hydroxide), acyl carnitine, L-tryptophan, and serotonin hydrochloride.

In the previously-known electrochemical biosensor that use a glassy carbon electrode with a surface that has been modified by a liquid suspension of CNTs and another material, the electrodes described herein may be substituted and used in place of the liquid suspension to modify the glassy carbon electrodes.

Methods are also provided herein for making the electrodes. In one embodiment, a suspension is formed that comprises the metal particles and CNTs, or at least one mediator titrant and CNTs. The suspension is then filtered to obtain the modified CNT sheet. The modified CNT sheet may then be washed and dried by any means known in the art.

In some embodiments, a surfactant is added to the suspension of CNTs and metal particles, or CNTs and at least one mediator titrant. Any surfactant known in the art may be used. In certain embodiments, the surfactant is biocompatible. Prior to forming the suspension, the CNTs may be functionalized. For example, the CNTs may be acid-functionalized, amino-functionalized, or acid-modified. In some embodiments, the CNTs are functionalized with carboxyl groups.

In some embodiments, the modified CNT sheets are arranged on a glassy carbon electrode. The modified CNT sheets may be arranged on the glassy carbon substrate with the aid of a solution or other known means. The modified CNT sheets may be arranged directly to the glassy carbon substrate. The arranging of the modified CNT sheet on a glassy carbon electrode may securely or removably dispose the modified CNT sheet on the glassy carbon electrode. The modified CNT sheets may be shaped or cut to a desired size, and may be arranged on the glassy carbon electrode using any known techniques. A solution may be used to aid the placement of the modified CNT sheet on the glassy electrode.

Specific methods for forming the electrodes are presented in the following non-limiting examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### EXAMPLES

### Example 1

### Preparation of Acid-Functionalized Carbon Nanotubes

An acid solution was prepared by combining 750 mL of sulfuric acid (98%) with 250 mL of nitric acid (65%) to produce a 3:1 v/v mixture of H₂SO₄:HNO₃.

200 mg of MWNTs or SWNTs were added to 200 mL of the acid solution. The solution was sonicated for 4 hours at 50° C. using a bath sonicator. The MWNTs or SWNTs were separated from the solution via filtration with a glass membrane. The MWNTs or SWNTs were then rinsed with 300 mL of deionized water. This process was repeated until the waste solution was no longer acidic. The acidity of the waste solution was measured using litmus paper or a pH meter. After rinsing, the MWNTs or SWNTs were allowed to dry for 24 hours.

### Example 2

### Addition of Gold Particles to CNTs

60 mg of acid-functionalized MWNTs and 60 mg of acid-treated SWNTs (from Example 1) were added to 150 mL of a 0.01 M solution of N-methylpyrolidone (NMP) and HAuCl₄ (Sigma-Aldrich) particles to form a mixture. Although the concentration of the particle solution was 0.01 M in this example, the concentration generally may range from about 0.01 M to about 0.001 M. The mixture was sonicated for 45 minutes by probe sonication before it was filtered to obtain the modified CNT sheet.

### Example 3

### Addition of Gold Particles to CNTs

Alternatively, the gold particles were added to the CNTs using the following method. A first solution was prepared by mixing 100 mg of acid-treated CNTs (50 mg MWNTs, 50 mg SWNTs) (from Example 1), 300 mg of Triton-X100 (Sigma-Aldrich), in 150 mL of water. The first solution was sonicated for 45 minutes. A second solution was prepared that was 500 mL of a gold colloidal solution, having particle sizes of gold below 100 nm.

The second solution was prepared by adding 0.25 g of solid HAuCl₄, 3H₂O (Sigma-Aldrich) to 25 mL of deionized water. The resulting 1% solution was further diluted with deionized water to a 0.01% solution, which was yellow in color. This yellow solution was heated to 3000° C. to rapidly boil it (with stirring). Under boiling conditions 7 mL of 1% trisodium citrate solution was added. The boiling solution was removed from the heat when it turned deep red, i.e. Au⁺³ ions were reduced to neutral gold atoms where the citrate ion acted as a reducing as well as a capping agent. The red color of the solution, in this example, indicated submicron gold particles, i.e., colloidal gold particles.

The first and second solutions were mixed together and sonicated in a bath sonicator for 2 hours. The resulting solution was then filtered with a filter membrane to obtain the modified CNT sheet.

### Example 4

### Preparation of Amino-Functionalized CNTs and Addition of Gold Particles

20 mg of carboxylated MWNTs or carboxylated SWNTs and 2 mg of o-(benzotriazol-1-yl)-1,1,3,3-tetramethyluroniumhexafluorophosphate (HBTU) were dispersed in 10 mL of ethylene diamine. The HBTU was added as a coupling agent. The dispersion was sonicated for 4 hours, then diluted with methanol, filtered through 10 μm pore size filter paper, and washed. The amino-functionalized CNTs were then dried at 80° C. in a vacuum oven for 4 hours.

20 mg of the amino-functionalized MWNTs were dispersed by sonication in 200 mL of deionized water for 10 minutes. 100 mL of a gold colloidal solution (as described in Example 3) was then added to the dispersion and sonication was continued for 1 hour. The dispersion was then filtered with a 10 μm pore size filter paper to obtain a filtrate. The filtrate was washed extensively with deionized water, and dried in a vacuum over at 80° C. for 4 hours. The process was repeated for the amino-functionalized SWNTs.

50 mg of the filtrate from the MWNT dispersion and 50 mg of the filtrate from the SWNT dispersion were mixed and sonicated in 150 mL of NMP for 4 hours. The NMP solution was filtered to obtain the modified CNT sheet.

### Example 5

### Preparation of Citric Acid-Modified CNTs and Addition of Gold Particles

Pristine MWNTs were treated with an anionic dispersant of citric acid by ultrasonication. The prepared citric acid-coated MWNTs were then immersed in 50 mL of a citric acid aqueous solution. The solution was then sonicated for 3-5 minutes.

After sonication, 50 mL of 0.2 gm of auric chloride solution was added dropwise to the CNT suspension under vigorous stirring at 700° C. The stirring was continued for 1 hour and the suspension was kept at 800° C. for 8 hours, filtered, and dried.

100 mg of the dried citric acid/gold-modified CNTs were then sonicated with 150 mL of NMP and filtered with a BP filter paper to obtain the modified CNT sheet.

### Example 6

### Preparation of a Dendritic Gold-Modified CNT Sheet

The dendritic gold particles were prepared by mixing DTAB (0.50 mL of 0.05 M solution), 0.25 mL of a 0.05 M solution of cyclodextrin, and 3.85 mL of water at room temperature. The mixture was stirred for 1 hour at 27° C. to produce mixture 1.

To mixture 1 was added 0.10 mL of a 0.01 M solution of HAuCl₄, 3H₂O and 0.30 mL of a 0.10 M solution of ascorbic acid. The resulting solution was kept for 12 hours without shaking.

Alternatively, the following were added to mixture 1:100 μL of a 1% gold solution and 100 μL of a 0.75% solution of sodium borohydride that was added dropwise.

In yet another alternative, the following were added to mixture 1:50 mL of 0.0001 M HAuCl₄, 3H₂O aqueous solution and 0.005 g of NaBH₄ in ice cold water.

To make the MWNT/dendritic gold and SWNT/dendritic gold sheets, 25 mg of acid functionalized MWNT or 25 mg of acid functionalized SWNT sheets were mixed with 1 mL of DTAB (0.05 M) and 0.50 mL of 0.05 M beta-cyclodextrin and mixed well in 10 mL water. Then, 1 mL of HAuCl4 and 1 mL of 0.75% sodium borohydride were added dropwise and stirred for an hour. The resulting suspension was filtered to obtain a CNT sheet modified with dendritic gold.

The CNT sheet modified with dendritic gold was then dispersed in 150 mL of NMP with soniciation for 2-4 hours. The suspension was filtered and the obtained modified CNT sheet was dried.

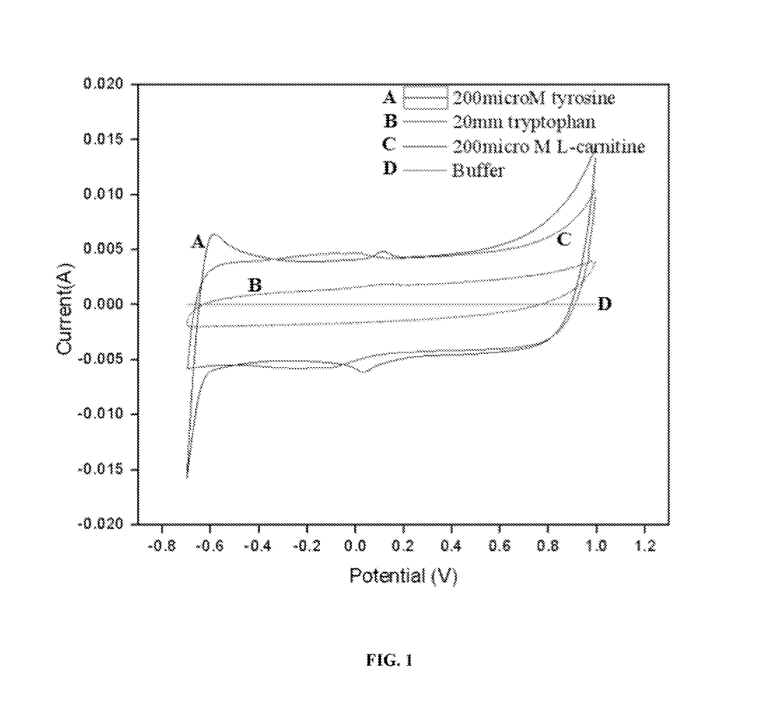

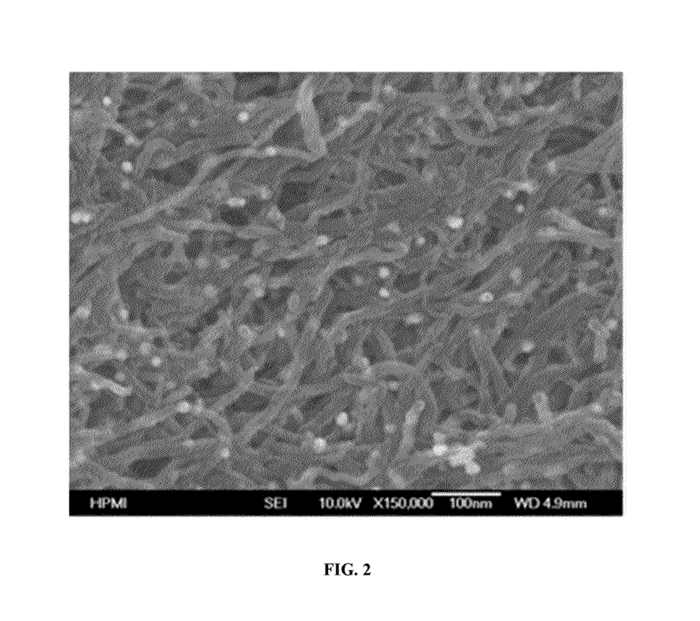

The CNT sheet modified with dendritic gold particles was then used as the working electrode in a three electrode system containing a counter electrode (Pt), a reference electrode (Ag-Agcl) and the working electrode. The electrolye was 1M PBS buffer, pH 7.4. The cyclic voltammetry data collected with the CNT sheet modified with dendritic gold particles for tyrosine, tryptophan, and L-carnitine are shown in FIG. 1. A scanning electron micrograph of the CNT sheet modified with dendritic gold particles is shown in FIG. 2.

### Example 7

### Modification of Glassy Carbon Electrode by MWNT-MB Dispersion and MWNT-MB Buckypaper

Methylene blue (MB), myoglobin and phosphate buffer solution were purchased from Sigma Aldrich, USA. MWNTs were purchased from SWeNT. All experiments in this example were performed using a conventional 3 electrode system. An Ag/AgCl electrode saturated in KCl was used as a reference electrode, and a platinum rod was used as a counter electrode. Three different working electrodes were used: a glassy carbon electrode, a modified glassy carbon electrode, and a sheet of buckypaper.

All measurements were performed using a VersaSTAT 3 potentiostat coupled with versa studio software. Atomic force microscopy was done to analyze and view the surface characteristics of the modified buckypaper. Conductivity of the buckypaper was measured using a 4-probe conductivity meter.

For comparison purposes, the glassy carbon electrode was modified by a MWCNT-MB dispersion and an MWNT-MB buckypaper.

In order to prepare a dispersion of MWNTs and MB, 3 mg of acid modified MWNTs were dissolved with 5 mg of MB by sonication for about two hours, then filtered and washed with DI water. The MWNTs were functionalized with carboxyl groups by a known method (Guo, Y., et al. ELECTROCHEMICA ACTA 55, 2010, 3927-3931). The solid nanohybrid material was then re-dispersed in 250 microliters of water. This dispersion (2 microliters) was used to coat 3 mm of the glassy carbon electrode surface, which was then dried for about 6-8 hours.

Multiple methods were used to combine carbon nanotubes with MB successfully while maintaining the structural stability of the buckypaper. The methods used included sonication, pressure filtration, vacuum filtration, or a combination thereof. For example, in the following experiment, a combination of sonication and pressure filtering obtained good results.

MWNT (120 mg) was mixed with 300 mg of MB in 600 mL of DI water and sonicated for 1 hour. After the MWNT and the MB were properly sonicated, 650 mg of Triton X was added to 100 mL of DI water and sonicated for 30 seconds. The Triton X surfactant was used to keep the structural stability of the buckypaper intact while the MB was added to the MWNTs. Both solutions were mixed together and sonicated for 15 minutes, and subsequently filtered using a pressure filtration unit (90 mm discrete volume pressure filter, Cole Palmer) with polycarbonate filter paper.

After filtration, the buckypaper was washed repeatedly with DI water to wash out the excess MB. The buckypaper was removed from the pressure filter and placed in DI water overnight. After 24 hours, it was removed from the DI water and placed in isopropyl alcohol for 24 hours. The buckypaper was then removed from the isopropyl alcohol and placed in DI water to remove the isopropyl alcohol. This washing process removed excess MB and Triton X. Using about 1 microliter of nafion solution, a small piece of the buckypaper was then cut precisely to cover a 3 mm surface of glassy carbon electrode.

### Example 8

### Morphology of Modified MWNT Buckypaper

This example demonstrated that the unique properties of functionalized buckypapers allow them to be used as a supporting material to which MB may be attached with increased stability.

The surface structure of MB-modified buckypaper from Example 7 was observed in a JEOL Ltd. Environmental Scanning Electron Microscope (ESEM) and in Bruker Co. Atomic Force Microscope (AFM).

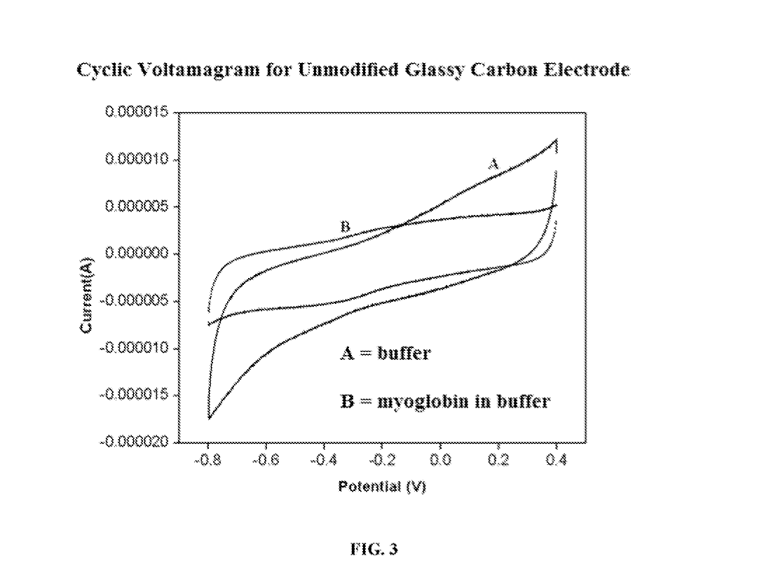

The electrical conductivity of the MB-modified MWNT buckypaper was measured using a 4-probe method, and was found to about about 60 s/cm. In the electrochemical experiments, simple glassy carbon electrodes were tested in phosphate buffer (PBS, pH=7), and in myoglobin solution (0.01 mM) in PBS. The cyclic voltammograms are shown in FIG. 3. The scan rate was 50 mV/sec and the cycles were run from 0.4 to −1 V. No oxidation peak was observed in any of the voltammograms, which indicated no interaction with myoglobin and unmodified glassy carbon electrode.

The cyclic voltammogram results from the glassy carbon electrode which was coated with the MWNT-MB dispersion showed a reversible redox reaction and oxidation and reduction peaks at 0.25 V and 0.40 V. The peaks were very symmetrical and the ratio of redox peak current was about 1, which indicate a reversible reaction by the nanohybrid material with myoglobin, and the small peak to peak distance indicated faster electron transfer rate.

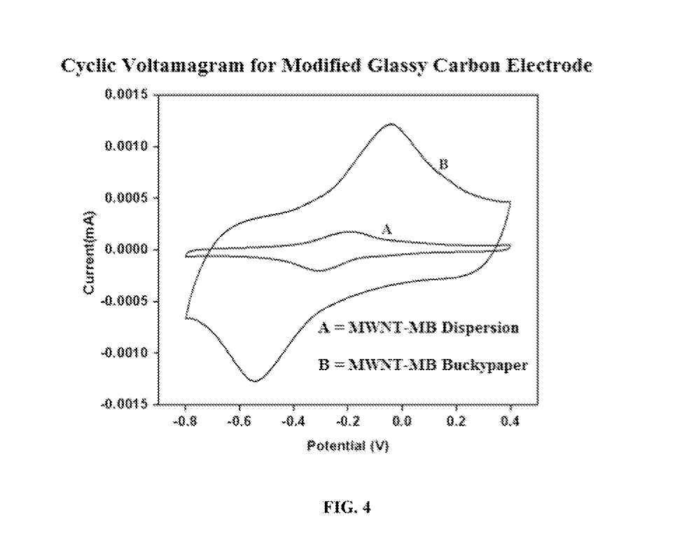

Although these results showed sensitivity to myoglobin in comparison to the baseline tests, the peak current was in the micro ampere (˜180 microA--˜200 microA) range as shown in FIG. 4. When a similar experiment was done with the buckpaper modified glassy carbon electrode, the oxidation-reduction peak shifted and the peak current range was in the milliampere range (about ˜150 mA). This change in peak current and shift in oxidation and reduction peaks indicated strong interaction with MWNT-BP with myoglobin. Not wishing to be bound by any particular theory, it is believed that this can be explained by the enhanced surface area and electrical conductivity of modified buckypaper compared to the dispersion of MWNT and MB. The difference of two orders of magnitude in the current response indicated a superior sensitivity when using buckypaper.

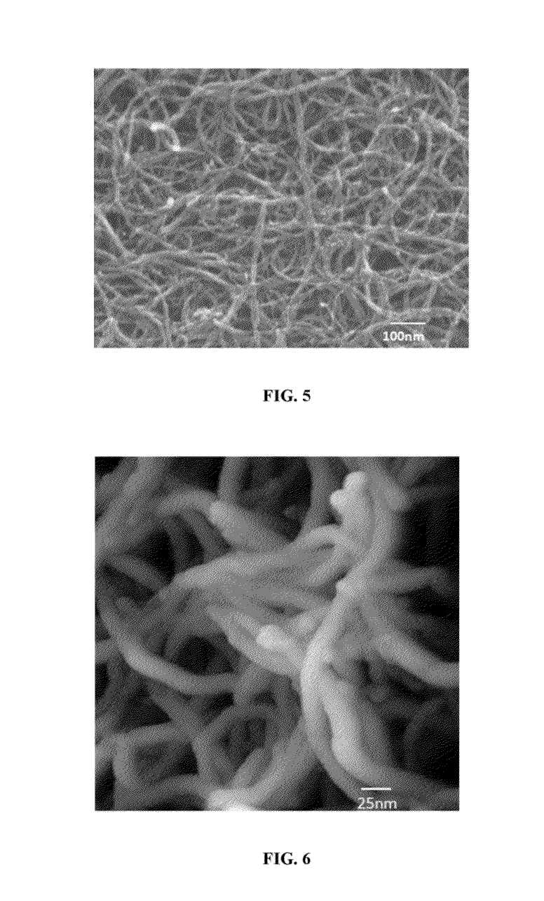

The micrographs obtained using SEM and AFM are shown in FIG. 5 and FIG. 6, respectively. The MWNT mat is clearly seen in these micrographs and no specific changes were observed due to the coating of MB on the CNTs.

These experiments demonstrated a significant increase in electrochemical response when MWNT-MB buckypaper was used to modify glassy carbon electrodes compared to MWNT-MB dispersion. The results were reproducible. The concentration of MB and MWNT can be varied to optimized sensitivity.

We claim:

1. A method for making an electrode comprising:
forming a suspension comprising carbon nanotubes at least one mediator titrant;
filtering the suspension to obtain a modified carbon nanotube sheet; and
arranging the modified carbon nanotube sheet on a glassy carbon electrode.

2. The method of claim 1, wherein the at least one mediator titrant comprises methylene blue, thionine, or PMS.

3. The method of claim 1, wherein the carbon nanotube sheets comprise SWNTs, MWNTs, carbon nanofibers, or a combination thereof.

4. The method of claim 1, wherein the carbon nanotubes are acid-functionalized, amino-functionalized, acid-modified, or a combination thereof.

5. The method of claim 1, wherein the carbon nanotubes comprise carboxyl groups.

6. An electrode comprising a carbon nanotube sheet modified with at least one mediator titrant.

7. The electrode of claim 6, further comprising a glassy carbon electrode, wherein the carbon nanotube sheet is disposed on the glassy carbon electrode.

8. The electrode of claim 6, wherein the at least one mediator titrant comprises methylene blue, thionine, or PMS.

9. An electrode comprising a carbon nanotube sheet modified with metal particles.

10. The electrode of claim 9, wherein the metal particles are non-covalently bound to the carbon nanotube sheet.

11. The electrode of claim 9, wherein the metal particles comprise nanoparticles.

12. The electrode of claim 9, wherein the metal particles comprise gold.

13. The electrode of claim 9, wherein the carbon nanotube sheets comprise SWNTs, MWNTs, carbon nanofibers, or a combination thereof.

14. A method for making an electrode comprising:
forming a suspension comprising carbon nanotubes and metal particles; and
filtering the suspension to obtain a modified carbon nanotube sheet.

15. The method of claim 14, further comprising the step of functionalizing the carbon nanotubes prior to forming the suspension.

16. The method of claim 14, further comprising arranging the modified carbon nanotube sheet on a glassy carbon electrode.

17. The method of claim 14, wherein the suspension comprises a surfactant.

18. The method of claim 14, wherein the carbon nanotubes comprise SWNTs, MWNTs, carbon nanofibers, or a combination thereof.

19. The method of claim 14, wherein the metal particles comprise gold.

20. The method of claim 14, wherein the metal particles are nanoparticles.
